(19) United States
(12) Patent Application Publication
(10) Pub. No.: US 2004/0204842 A1
(43) Pub. Date: Oct. 14, 2004

(54) Information providing system capable of providing user with route information and advertisement

(76) Inventor: Noboru Shinozaki, Tokyo-to (JP)

Correspondence Address: NIXON & VANDERHYE, PC, 1100 N GLEBE ROAD, 8TH FLOOR, ARLINGTON, VA, 22201-4714, US

(21) Appl. No.: 10/288,300

(22) Filed: Nov. 6, 2002

(30) Foreign Application Priority Data
Nov. 20, 2001 (JP) P2001-354073

(51) Int. Cl. G01C 21/34

(52) U.S. Cl. 701/209; 340/990; 340/995.17

(57) ABSTRACT

An information providing system is provided for providing both of a map and positional information depicted to be on the map to a communicable terminal connected to the system via a network. In the system, an information provider is allowed to register both of a spot showing a desired position on the map and advertisement for the spot. Date showing a current position of an information user is acquired. Both of the spot and the current position of the information user are displayed on the map. Route information connecting the spot and the current position of the information user is then produced, if the spot is selected by the information user, and on the map, the produced route information is then displayed and the advertisement for the spot is delivered to the terminal for display.

### BACKGROUND OF THE INVENTION

The present invention relates to an information providing system capable of providing a user with a route from a current position to a desired target position on a map, together with advertisement related to the target position.

In recent years, a navigation system for guiding a vehicle has been widely used, where a display unit such as a liquid crystal display panel is mounted on the vehicle to display maps. One type of recent navigation systems, which have been eagerly researched for practical use, is a “communicating navigation system.” In this system, there are provided an information server and on-vehicle navigation terminals. The information server has a database in which pieces of information about maps are stored. Pieces of map information are delivered to each on-vehicle navigation terminal by making use of communication lines. Each on-vehicle terminal detects data of vehicle's current position, and provides crew members with pieces of navigating information based on the delivered map and the detected vehicle's current position.

A new type of navigation system, known as a “mobile navigation terminal,” has also been studied for practical use in the field of mobile terminals such as portable phones. The mobile terminal is able to measure distances between its current position and each of a plurality of fixed phone base stations by the use of radio waves, and compute its current position based on the measurements. The mobile terminal uses the computed current position to provide a user with information necessary for the navigation. Hence, like the on-vehicle navigation terminal, the mobile navigation terminal has the capability of navigating the user.

However, the foregoing various types of navigation systems (terminals) do not always meet a demand that a spot, such as a shop, pulls in more customers. If using the navigation system (terminal), a user (i.e., customer) is able to reach a desired place with the aid of the navigation function provided by the system. Such a simple navigation is short of positive attraction for customers.

Some navigation systems (terminals) are able to show advertisement sponsored by information providers. However, such advertisement is not always connected to the route information on a direct basis. Hence, the conventional systems (terminals) are lower in the ability of attracting users and gathering them to spots, such as shops, amusement parks, theaters, or any other places.

### SUMMARY OF THE INVENTION

The present invention has been made in view of the above circumstances, and an object of the present invention is, therefore, to provide an information providing system capable of providing users with route information and advertisement in an attractive manner.

In order to realize the above object, the present invention provides, as one aspect, an information providing server for providing a communicable terminal connected to the system via a network with both of a map to be displayed on the terminal and positional information depicted to be on the map. The server comprises a registration receiving unit configured to receive registration of a spot showing a desired position previously provided by an information provider; a users' position acquiring unit configured to acquire information about a current position of an information user; a first displaying unit configured to display on the map both of the spot registered by the spot registration receiving unit and the current position of the information user acquired by the users' position acquiring unit; a route information producing unit configured to produce route information connecting the spot and the current position of the information user, in cases where the spot registered by the spot registration receiving unit is selected by the information user; and a second displaying unit configured to display the produced route information on the map.

It is preferred that the server further comprises a delivering unit configured to deliver to the terminal information related to the spot, wherein the registration receiving unit includes a unit configured to receive registration of the information related to the spot, the information being previously provided by the information provider together with the spot.

Accordingly, in cases where any of the spots previously registered is selected by an information user, data of a route connecting the selected spot and a current position of the information user is produced. The data of the route is displayed on a map, so that a route from the user's current position to the selected spot (e.g., a desired shop) is shown on the map. Showing this route enables the information user to go to the spot more readily.

Further, the registered spots are associated with information related to the spots, including advertisements for the spots. Hence by selecting a desired spot on a map, the information user is able to obtain various kinds of information about the selected spot, including the advertisement for the selected spot. Concurrently providing a user with both the route to a target spot and related information about the target spot makes it possible to give the spot a greater attraction to gather more users.

According to another aspect, the present invention provides a method of providing a communicable terminal, via a network, with both of a map to be displayed on the terminal and positional information depicted to be on the map. The method comprises the steps of: receiving registration of a spot showing a desired position previously provided by an information provider; acquiring information about a current position of an information user; first displaying on the map both of the registered spot and the acquired current position of the information user; producing route information connecting the spot and the current position of the information user, in cases where the registered spot is selected by the information user; and second displaying on the map the produced route information.

It is preferred that the method includes the step of delivering to the terminal information related to the spot, wherein the information is previously provided by the information provider together with the spot. The information includes an advertisement for the spot.

### BRIEF DESCRIPTION OF THE DRAWINGS

Other objects and aspects of the present invention will become apparent from the following description and embodiments with reference to the accompanying drawings in which:

FIG. 1 is a block diagram showing an outlined configuration of an information providing system according to one embodiment of the present invention;

FIG. 2 is a block diagram detailing the configuration of a terminal incorporated in the information providing system;

FIG. 3 shows a flowchart for registration procedures of spots and information related spots in the information providing system;

FIG. 4 exemplifies a picture to be displayed on a terminal during the performance of the registration procedures;

FIG. 5 exemplifies another picture to be displayed on the terminal during the performance of the registration procedures;

FIG. 6 is a flowchart showing procedures required when users use the service provided by the information providing system;

FIG. 7 illustrates one picture to be displayed on a terminal when making use of the service;

FIG. 8 illustrates another picture to be displayed on the terminal when making use of the service;

FIG. 9 illustrates another picture to be displayed on the terminal when making use of the service; and

FIG. 10 illustrates another picture to be displayed on the terminal when making use of the service.

### DETAILED DESCRIPTION OF THE PREFERRED EMBODIMENT

The present invention will now be described with reference to preferred embodiment.

In the following embodiment, the present invention is practiced into an information providing system that provides “client guide service” by allowing an “information provider” to provide an “information user” with pieces of information such as advertisements. Practically, in such cases, the information providing system is capable of representing, on an information user's terminal, a route from a current position at which the information user is present to a target location, such as a shop, from which an advertisement is provided. Thus, it is possible that the information providing system directs, to the target location, information users who looked at the advertisement.

In the following, exemplified is a group in which group's manager is responsible for management of the client guide service, while group's members are information providers, such as business organizations, that advertises for clients by making use of the client guide service. In addition, ordinary users to be serviced, who are outside the group, correspond to information users.

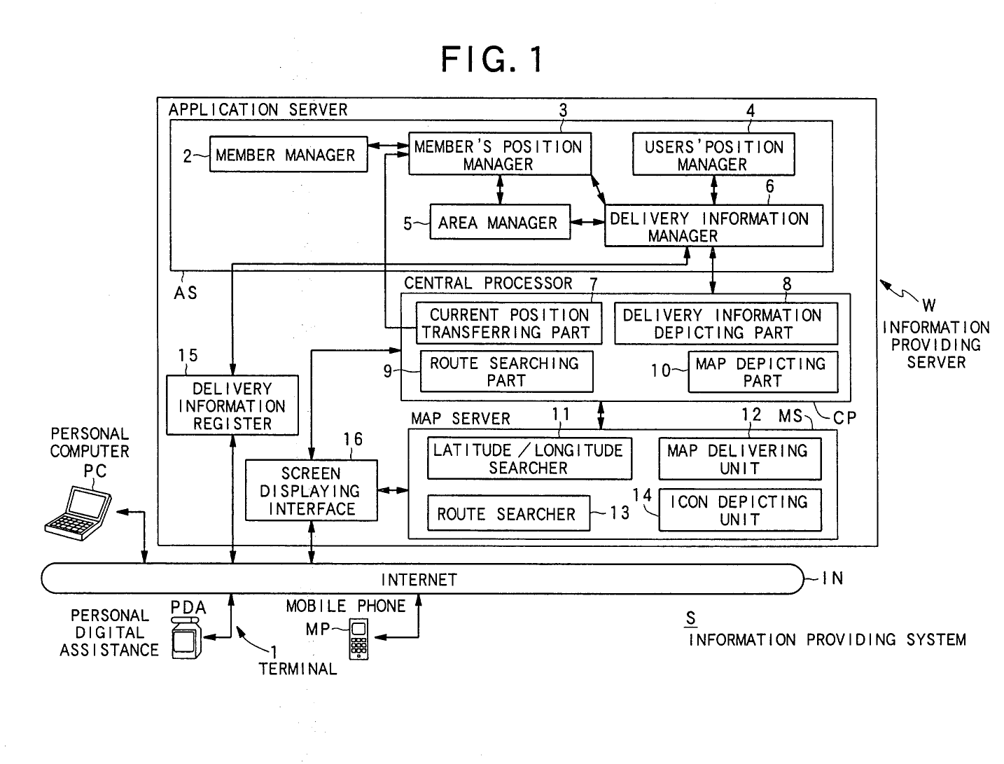

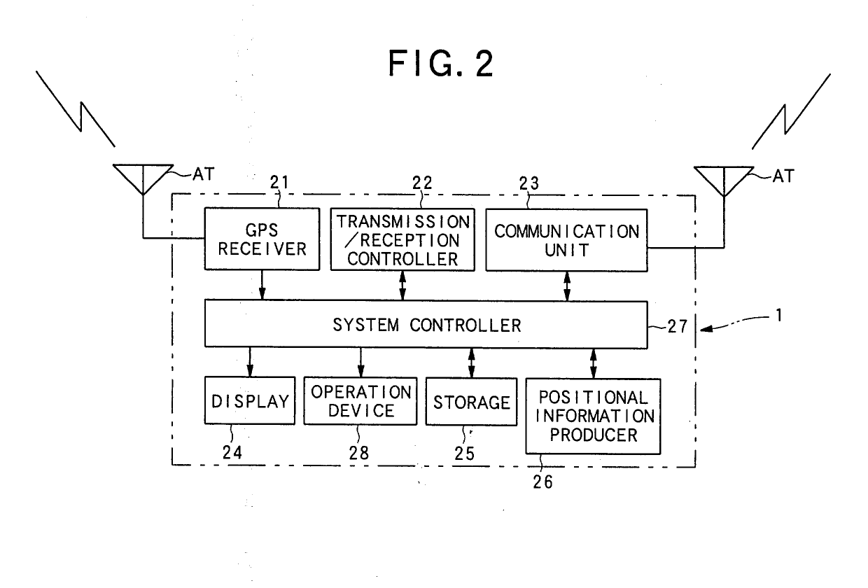

First, referring to FIGS. 1 and 2, the configuration of an information providing system according to an embodiment will now be outlined. FIG. 1 shows in a block form an outlined configuration of the information providing system, and FIG. 2 details the configuration of a terminal to be incorporated in the information providing system.

As shown in FIG. 1, the information providing system S according to the present embodiment is formed into a system to provides information users with both of a map and positional information depicted on the map through the Internet IN. The information providing system S includes an information providing server W and information user's terminals, such as personal computers PC, mobile personal digital assistance units PDA, and mobile phones MP, that are connectable to the information providing server W. The server W is used such that information providers (group's member) previously stores information about “the location of a shop to be advertised” (hereafter, frequently referred to as a “spot”) into the server W and the server W operates, when needed, so as to display the spot on an information user's terminal. When an information user (group's non-member and/or other group's member) records the current position on a map, and selects a desired shop from shops that have been advertised, a route connecting the shop and the current position is displayable on the user's terminal.

In the present embodiment, the personal computer PC, mobile personal digital assistance units PDA, and mobile phone MP are in charge of the same function in the information providing system. Those units are therefore noted as a terminal 1 serving as a communication terminal.

The information providing server W includes, as shown in FIG. 1, an application server AS that functions as spot registration accepting means and user's location acquiring means, a central processor CP that serves as route information producing means, a map server MS, a delivery information register 15, and a screen displaying interface 16 that acts as displaying means.

The delivery information register 15 intervenes between the Internet IN and the application server AS so that it relays information therebetween. Also the screen displaying interface 16 is placed to relay information between the Internet IN and the central processor CP and map server MS, so that pictures displayed on the terminal 1 is under the control of the screen displaying interface 16.

The application server AS includes a member manager 2, member's position manager 3, users' position manager 4, area manager 5, and delivery information manager 6.

The member manager 2 is configured to relay necessary pieces of information to and from the member's position manager 3. The member's position manager 3 is able to send and receive pieces of information to and form both of the area manager 5 and delivery information manager 6, in addition to the capability of acquiring current positional information indicative of ‘a user’s position from a current position transferring unit (later-described) in the central processor CP. The users' position manager 4 is placed to send and receive pieces of information to and from the delivery information manager 6. The area manager 5 is placed to send and receive pieces of information to and from both the member's position manager 3 and the delivery information manager 6. Further, the delivery information manager 6 is configured to communicate with the area manager 5, delivery information register 15, users' position manager 4, and central processor CP.

The map server MS, which is able to communicate with both of the central processor CP and the screen displaying interface 16, includes a latitude/longitude searcher 11, map delivering unit 12, route searcher 13, and icon depicting unit 14.

Moreover, the central processor CP is configured so that it is in charge of data communication to and from the delivery information manager 6, screen displaying interface 16, and map server MS. More practically, the central processor CP functionally includes a current position transferring part 7, delivery information depicting part 8, route searching part 9, and map depicting part 10. Of these, the current position transferring part 7 is responsible for transferring current positional information about an information user to the member's position manager 3.

Each of the foregoing components will now be detailed.

The delivery information register 15 serves as an interface between the delivery information manager 6 and the terminal 1 (such as the personal computer PC, mobile information digital assistance PAD unit, or mobile phone MP) and is communicable with the terminal via the Internet IN.

The screen displaying interface 16 receives current positional information indicative the position of an information users from the terminal 1 through the Internet IN, and presents the current positional information on a map. In addition, this unit 16 receives a spot showing a desired position, which is provided by an information provider, and then represents on a map the spot, together with an indication of a route linking the spot and the current position.

The components in the application server AS will now be described. The member manager 2 engages in management processes of the members (group's members) through communication with the member's position manager 3. Practically, the management processes include an initial registration process, withdrawal process, and membership fee management process for both of information providers (group's members) who make use of information provided by a manager of this shop group and information users (non-members) who receives information.

The member's position manager 3 is responsible for the management of current positional information in relation to one ore more members who compose the group. The users' position manager 4 manages locations at which information users are present at present. Still, the area manager 5 engages in the management of route display areas determined based on spots that information providers registered. The delivery information manager 6 manages both of pieces of information transmitted from information users and pieces of information to be transmitted to information users.

Further, in the map server MS, the latitude/longitude searcher 11 searches both latitude and longitude at a spot registered on the terminal 1 through the screen displaying interface 16. Incidentally, the registration of a spot on the terminal 1 is realized by selecting a single desired spot on a map that has been displayed by the terminal 1. However, in this registration stage, the latitude and longitude do not give information indicative of the selected spot yet, and the spot is just selected for registration on condition that the spot has an address on the map.

The map delivering unit 12 delivers to the central processor CP information such as map data necessary for displaying a map desired by an information user, so that the map data and other necessary information are sent to the terminal 1 through the Internet IN.

The route searcher 13 produces piece of information that indicate a route connecting a spot provided by an information user to the current position of an information user. The icon depicting unit 14 will depict an icon on a map, in cases where data indicative of the map is outputted from the information providing server W.

The central processor CP will now be explained with its functional blocks. The current position transferring part 7 is capable of transferring information indicative of the current position of a member to the member's position manager 3. The delivery information depicting part 8 has the capacity of producing pictures, such as map pictures and route display pictures connecting an information user's current position to a spot registered by an information provider. Further, the route searching part 9 is capable of searching bits of information in relation to such a route. The map depicting part 10 is able to receive map data outputted from the foregoing map delivering unit 12, uses the map data to produce image data of a map to be displayed, and outputs the map information to the Internet IN.

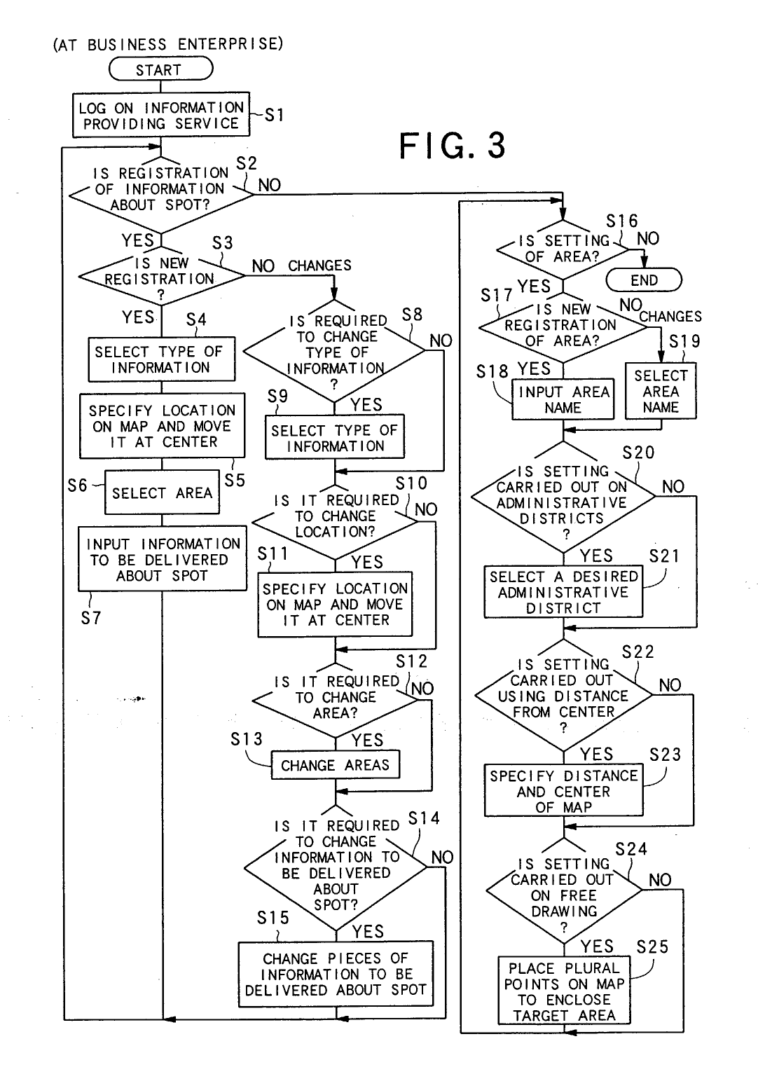

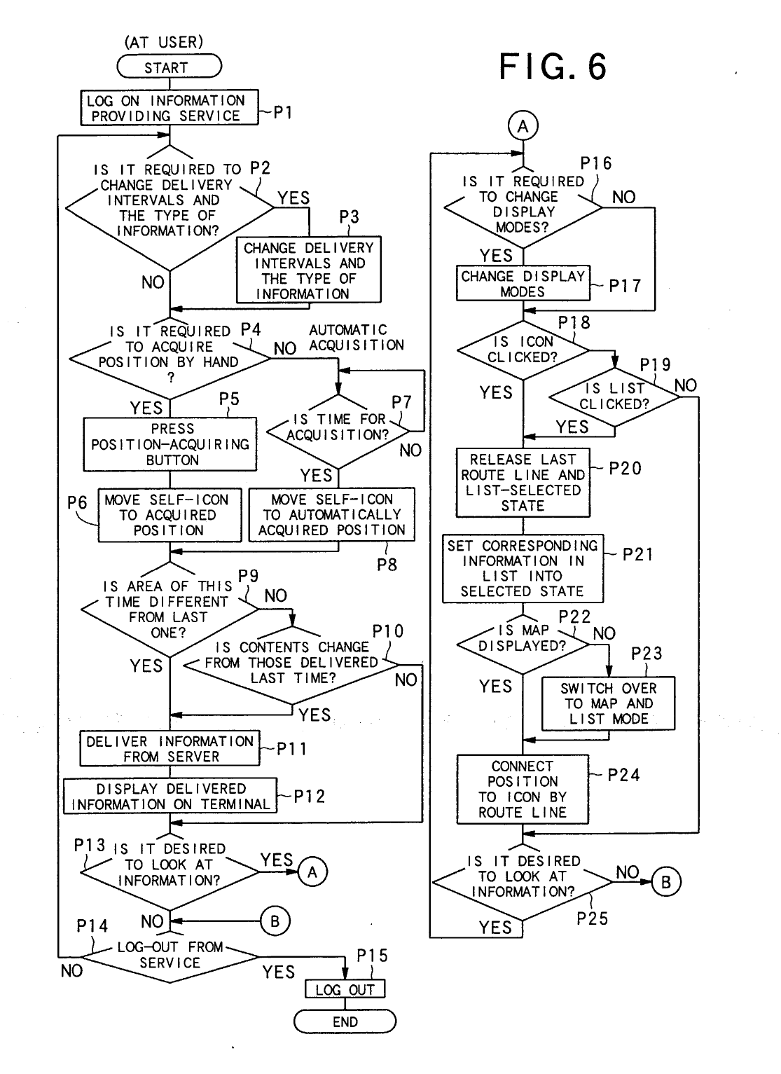

In the present embodiment, the programs in which the procedures for the processing shown in FIGS. 3 and 6, which will be described later, are written are stored in information recording mediums such as flexible disk or hard disks. The programs are read out by CPUs (computers) incorporated in the server W in order to realize the predetermined functions of the application serer AS, central processor CP, and map server MS.

Referring to FIG. 2, the configuration of the terminal 1 will now be detailed.

As shown in FIG. 2, the terminal 1, which is coupled with two antennas AT, is equipped with various components. The components include a GPS receiver 21, transmission/reception controller 22, communication unit 23, display 24, storage 25, positional information producer 26, system controller 27, and operation device 28.

Of these, the GPS receiver 21 receives GPS the data via one antenna and the transmission/reception controller 22 manages regularly transmitted conditions of the current position of an information user. The communication unit 23 is also coupled with the other antenna AT and in charge of transmitting necessary data to the information providing server W via the antenna AT. The display 24 is responsible for displaying, on a map, a spot (which shows a desired position provided by an information provider) received from the information providing server W by way of the Internet IN, a mark showing the current position of an information user, and a mark indicative of a route connecting the spot to the current position.

Further, the storage 25 is placed to store data indicative of spots that are desired locations provided by information providers, data indicative of current positions of information users, and data indicative of routes connecting the various spots and every possible current position. The positional information producer 26 will produce data indicating the current position of each terminal 1 with the aid of GPS data received via the GPS receiver 21. The system controller 27 uses both of received data and stored data in the storage 25 so that it controls each component in the terminal 1. The operation device 28 is placed to allow an operator to give pieces of necessary information to the terminal 1.

The GPS receiver 21 is configured to receive navigation radio waves coming from the GPS satellites through the antenna AT, and computes pseudo-coordinates corresponding to the current position of each information user so as to provide the pseudo-coordinates (i.e., GPS data) to the system controller 27.

In the present information providing system S, there are provided one or more groups each of which consists of one or more members for the purpose of sharing pieces of information based on a particular theme under the control of a group's manager. And in the system S, each member is entitled to register the spots serving as positions on a map. Moreover, concurrently with the registration of the spots, each member is allowed to register pieces of information related to show the registered spot. Hereafter, the information is referred to as “spot information.”

The “spot information” includes pieces of information about each shop (shop outline, sales information, and others), data of the latitude and longitude of a position of each registered spot on a map to be displayed, a name to be registered of each spot, the name of each member (registrant), and others. The “spot information” may also include data of images in relation to each spot to be registered.

The registered spot and its spot information can be set for disclosure by the authority of a member (hereafter, if necessity, referred to as a “registrant”) who performed the registration of the spot and its spot information. In this setting operation, the scope of the disclosure can be determined by specifying a desired disclosure level. In addition, the spot and its spot information can be opened to the public other than the members, according to the contents of the spot information.

The spot information is set so that it can be subject to predetermined operations, which include registration (writing in), enquiry (inspection), correction and deletion.

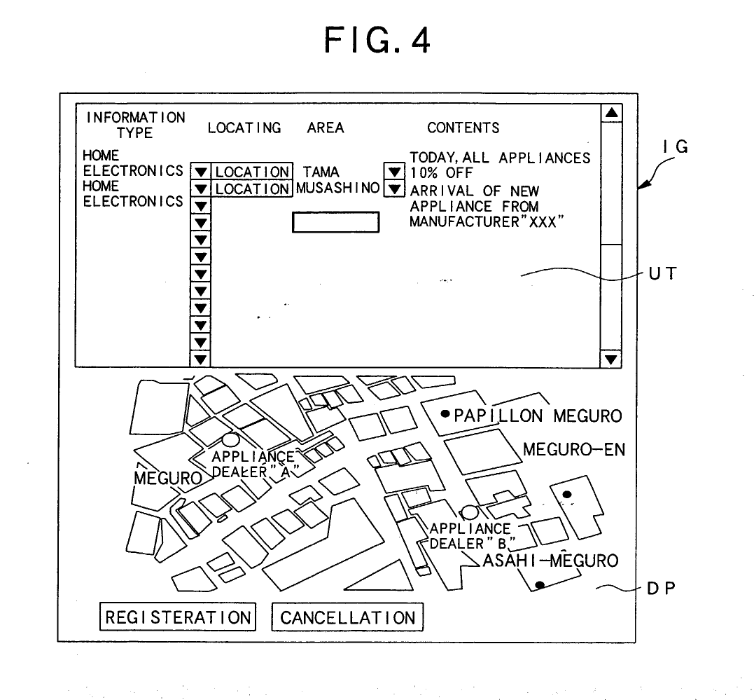

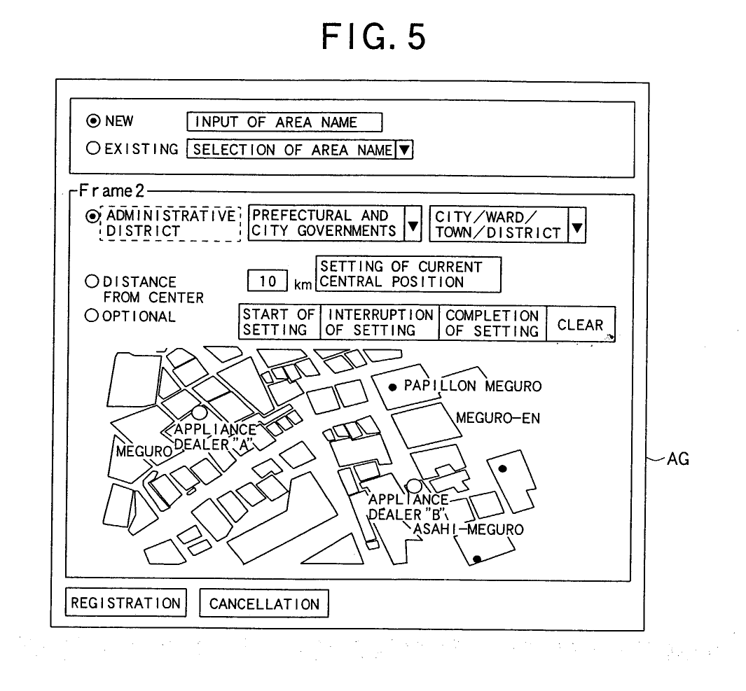

Referring to FIGS. 3 to 5, the procedures for registering of advertisement information in the information providing system S according to the present embodiment will now be explained. FIG. 3 is a flowchart showing the processing for the registration procedures carried out by the information providing server W, while FIGS. 4 and 5 each exemplify pictures to de displayed on the terminal 1 such as a personal computer PC during the performance of the registration procedures.

In the present embodiment, the first and second displaying unit of the present invention includes the screen displaying interface 16, the registration receiving unit and users' position acquiring unit of the present invention are substantially composed of the application server AS, and the route information producing unit of the present invention is substantially composed of the central processor CP.

The procedures explained below are given for registration of leading advertisements (spot information) provided by business enterprises (group's members) who make use of the service, so that the leading advertisements for ordinary users can be done. FIG. 3 indicates the procedures required when a business enterprise registers a leading advertisement. The administrator for the service (group's manager) is authorized to monitor the pieces of spot information that have been registered, and delete any piece of spot information if spot information of which contents are inappropriate for the disclosure is found. In cases where a leading advertisement is contracted on a time limit basis, the administrator will delete the leading advertisement when its contracted running term comes an end.

As shown in FIG. 3, in performing the registration procedures according to the present embodiment, a group's member first logs on the information providing service through the terminal 1 owned by the member to the application server AS of the information providing server W (step S1). It is then determined by the application server AS if registration of spot information is carried out or not (step S2). Practically, when the member desires to register (and/or correct) information about a shop to be for leading advertisement (that is, spot information), the YES is chosen to proceed to step S3. By contrast, the information registration is not required (NO at step S2), the processing is made to skip to an area setting procedure described later.

It is then determined at step S3 whether or not it is desired that a leading advertisement be registered newly. That is, selected is either a leading advertisement should be registered newly or the current leading advertisement should be changed in terms of its contents. If the former (new registration) is selected (YES at step S3), a shop category is selected on an information setting picture shown in FIG. 4 (step S4). On the other hand, if it is desired that the contents of the leading advertisement be changed (NO at step S3), the processing is made to proceed to an information-type change procedure later described. Then, at step S5, a location is set on a map and the location is moved to the center of the map. A spot to show a shop is then registered on the map, before a corresponding area to the advertisement is selected (step S6).

To be specific, at step S6, an area to be targeted for the leading advertisement is selected from area patterns that were registered by the area setting procedure that will be described later. If a desired area could not found in the alternatives, the setting procedure is activated to register a desired area.

After the area selection, pieces of shop information, such as the outlined information about a shop, which will be accompanied with the spot showing the shop, and information in relation to sales, are registered (step S7). The processing then returns to step S2.

On the other hand, for changing the contents of a certain leading advertisement (NO at step S3), it is further determined whether or not it is desired that the type of information be changed (step S8). When it is required to change the contents (YES at step S8), a desired type of information (i.e., the category of a shop) is selected at step S9. By contrast, if such changes are not required (NO at step S8), the selection of step S9 is skipped.

Then, at step S10, it is further determined if or not it desired to change the current location of a shop to another one. When the determination is that the changes are needed (YES at step S10), the current location is moved to a desired other place on the map and its new location is made to be centered thereon (step S11). When such changes are not required (NO at step S10), the processing at step S10 is skipped.

The processing then goes to step S12, where it is determined whether or not it desired to change areas to be targeted for the leading advertisement. When it is determined that the changes should be made (YES at step S12), the current area is changed to another area (step S13). By contrast, when such changes are not needed (NO at step S12), the processing at step S13 is skipped.

After this, the processing proceeds to step S14, at which it is determined whether or not it is desired to change pieces of information to be delivered. When it is necessary to change the pieces of information to be delivered (YES at step S14), such changes is carried out (step S15), before the processing is made to return to step S2. However, when such changes is unnecessary (NO at step S14), the processing at step S14 is skipped, being returned to step S2.

In above steps of S4 to S15, the processing at steps S4, S5, S6 and S7 is similar in their processing contents to that at step S9, S11, S13 and S15, respectively.

The processing at steps S4 to S7 accompanies an information setting picture IG shown in FIG. 4, which is displayed on the display 24 of the terminal 1 placed at every business enterprise who has participated in the service. That is, the information setting picture IG is used by each business enterprise to input various pieces of data of contents to be delivered.

As shown in FIG. 4, the picture IG includes an information type button prepared in a combo box, in which various types of information which are the same as those on an information type picture that provides an information user with its selection. Thus, the business enterprise is able to select a desired information type on the information setting picture IG in accord with pieces of information to be registered.

The information setting picture IG also includes a location button, an area button, and a map display region DP. The location setting button is used to point at, on a map, a location at which a piece of information is present, and when pressing the button, the center of the map is set to be a designated location. The area button is used to select an administrative district, a market, and others that have been registered through an area setting process. Pieces of information that have been set will be delivered to information users who are within a selected area.

The map display region DP formed on the information setting picture IG responds to present, on the map, the pieces of information that have been set in an upper table UT, which appears in an upper area of the picture IG. On the display region DP, the colors of icons are different from each other depending on the type of selected information. Responsively to a click of a particular icon, an article in the upper table UT related to the clicked icon become selectable. In the information setting picture IG shown in FIG. 4, a registration button is pressed for registering the pieces of information that has been specified, while a cancellation button is pressed when it is needed to cancel all pieces of information that have been specified.

Returning to FIG. 3, in cases where the registration of information will not be carried out (NO at step S2), the processing is moved to step S16, where it is determined if the processing to set area patterns (area setting processing) is needed or not. When it is required to register an area pattern(s) (YES at step S16), the processing is made to go to another determination at step S17, while such a registration process is unnecessary (NO at step S16), the processing comes an end.

At step S17, it is further determined whether a new area pattern(s) should be registered the aid of an area setting picture AG shown in FIG. 5 or the currently registered area patterns should be corrected. When the new registration is selected (YES at step S17), the processing proceeds to step S18, at which an area name(s) is inputted through the operation device 28 of the terminal 1. In contrast, the determination shows the correction of area patterns (NO at step S17), an area name(s) subject to the correction will be newly selected (step S19).

The above new registration and correction processes are followed by step S20, where it is determined whether the area is designated on the administrative districts or not. If it is desired that the setting be made on the administrative districts (YES at step S20), a desired administrative district is set by selecting or specifying any prefectural and city government, city, ward, town, and district, before proceeding to step S22. Meanwhile, when the administrative districts will not be used (NO at step S20), the processing at step S21 is skipped.

The processing is made to proceed to step S22, at which it is determined whether or not each area is set by specifying a distance from the center thereof. In other words, a selection is made as to whether each area depends on “a certain radius (km) from the center placed at a shop (i.e., spot).” When the determination is affirmative (YES at step S22), the processing goes to step S23, where the center of a map and a distance (radius) from the center are designated, before proceeding to step S24. However, the determination is negative (NO at step S22), the step S23 is skipped.

After the above processing, at the next step S24, it is still determined if or not how to set areas is free drawing on a predetermined manner. If the free drawing is selected (YES at step S24), the processing is handed to step S25, where a plurality of points are specified on a map to enclose a freely shaped area to be targeted, before returning the processing to step S16. In contrast, the free drawing is not desired (NO at step S24), the processing is returned to step S16.

The processing at above steps S17 to S25 is carried out using the area setting picture AG shown in FIG. 5. For example, as for the processing at steps S17 to S19 (i.e., the processing for setting a new area or for correcting the current areas), an area name is inputted on the image AG when the new setting is required, while an area name is selected from the combo box when the area corrections are required on the image AG.

As to the processing at steps S20 and S21 (i.e., the administrative districts are used for setting a desired area), a selection is made on the area setting picture AG in order to selective a desire administrative district from the combo box thereon. Further, as to processing at steps S22 and S23 (i.e., an area is given by specifying a distance from a center), a circle of which radius is a given value appears on the picture AG so as to enclose an area centered at a given point, and the map is moved to determine a current central position by using a setting button. In cases where the processing at steps S24 and S25 is performed based on the free drawing, a polygonal area enclosed by plural points is registered. In this operation, the setting start button is first pressed, and then points are clicked on a map, so that the points are taken into the system as points for forming a polygonal area. The setting interruption button is used to interrupt the point-placing processing, which is needed in several operations including scrolling maps. After pressing the setting interruption button, no points will be produced even by clicking the map. Further, the setting completion button is pressed to produce an area by mutually connecting the clicked points with a line. The clear button, when pressed, returns the currently displayed setting picture to its initial setting picture, so that retrying the setting processing is allowed.

In FIG. 5, a button “register” is pressed to register an area that has been set. When it is required to delete all areas that have been set, a button “cancel” is pressed.

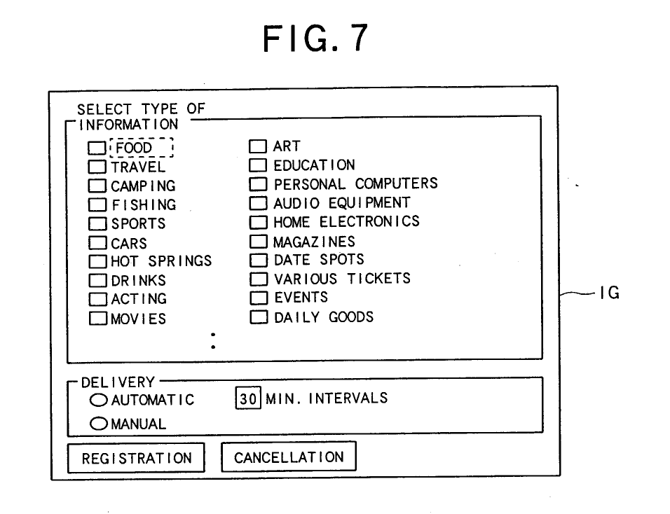

Referring to FIGS. 6 to 10, the processing for allowing an information user to make use of the information providing service given by the present information providing system S will now be described. FIG. 6 is a flowchart showing the procedures for the processing of the client guide service, whilst FIGS. 7 to 10 exemplify pictures that will be displayed on, for example, a certain personal computer PC in performing the procedures for the service. The processing shown in FIG. 6 is carried out by the information providing server W.

The procedures described below are necessary for ordinary information users to have an access to the information providing system S so as to serviced with the “client guide service.” These procedures differ partly, terminal by terminal, depending on each terminal 1 has the GPS function of sending data about a current position to the information providing server W at intervals.

As shown in FIG. 6, first, an information user is allowed to log on the information providing system S (step P1). The server W then determines if or not it is necessary to change a delivery interval and an information type (step P2). In cases where it is determined that both of the delivery interval and information type should be changed (YES at step P2), the processing for changing both the delivery interval and the information type is carried out (step P3). Through this processing at step P3, the information user is able to set the category of a desired shop and an interval of time for delivery of information about the shop.

Practically, on an information type setting picture IG displayed on the terminal 1 as shown in FIG. 7, the information user is to select the category of a shop (i.e., the type of information) from which the user desires to have its information. The selection can be made with corrections which are allowed at any time. Further, a plurality of types of information can be selected at a time. On this information type setting picture IG, the way of receiving information from the information providing server W to the terminal 1 can be chosen from “automatic” and “manual” buttons. When selecting the “automatic” button, automatic delivery is recognized in the server W, where pieces of information will delivered from the server W at specified intervals. Meanwhile, when selecting “manual” button, thus leading to manual delivery, pieces of information will be delivered whenever the information user presses an information display button on a main picture described later. Usually, this manual mode is directed to emergencies.

If both of the delivery interval and the information type will not be changed (NO at step P2), the processing goes to step P4, at which it is determined whether or not a current position of the user (i.e., the position at which the terminal 1 is currently present) is acquired in response to an operation done by hand. In other words, means for notifying the information providing server W of the user's current position is chosen at step P4. When the selection of NO is made at step P4, the position acquisition is decided to be an automatic mode, so that information indicting the current position, which is acquired with the help of the GPS function, will be sent to the information providing server W at regular intervals. In contrast, when the selection of YES is done at step P4, the information user is entitled to manually specify a current position, with data indicative of the current position transmitted to the server W. In this case, it is not always necessary to send the actual current position to the server W. In the case that the current position is outside the area in which a shop, about which the user is desired to have spot information, resides, the user is able to specify a desired position within the area in which the desired shop is present. The manually specified position is also sent to the server W.

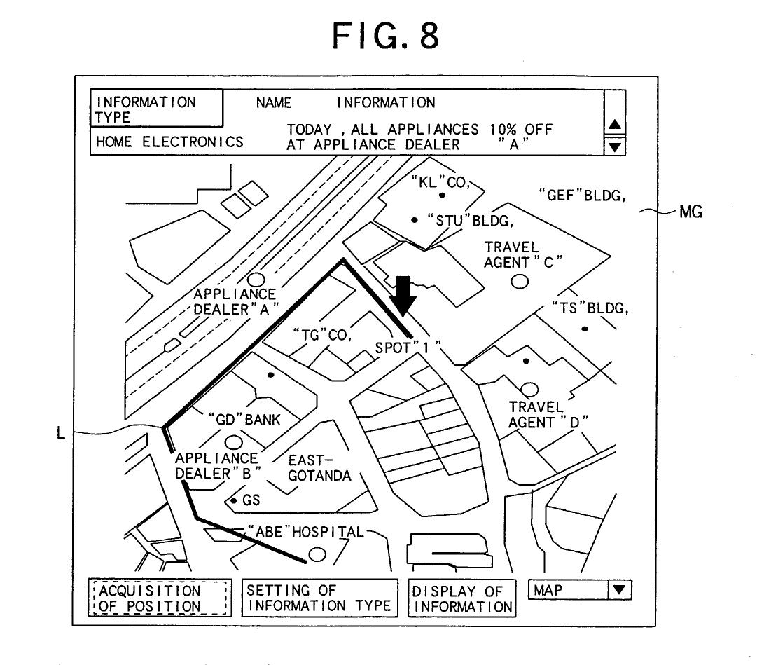

More practically, a main picture MG is displayed on the terminal 1 as illustrated in FIG. 8. The current position of the information user is acquired with the portable phone MP and PHS as well as the GPS. In the case of using the GPS, data indicative of a current position is sent to the information providing server W regularly. In this situation, the server W recognizes a user's position, so that it is preventable that the server W re-sends the same spot information to the user. However, the server W has the capability of re-sending pieces of information in cases where the contents of the information have been changed from those of information sent last time. Additionally, in this case, only information related to the current area (such as city/ward/town/district or market) may be transmitted from the server W to the terminal 1. Moreover, when immediately after the information user enters another area, the server W may sent necessary information to the terminal 1.

In the case of manually acquiring the current position (YES at step P4), a button “position acquisition” on the main picture MG shown in FIG. 8 is pressed, and in response to the pressing operation, a self icon is automatically moved to an acquired current position on the picture MG (steps P5 and P6).

On the other hand, for acquiring the current position automatically (NO at step P4), the acquisition processing is made to wait for until the next predetermined timing comes. At the next acquisition timing, the automatic acquisition is done with the aid of the GPS function, and a self-icon is automatically moved (updated) to the automatically acquired position on a map (steps S7 and S8). The data of the acquired current position is sent to the information providing server W.

It is then determined by the server W whether or not the area detected last time differs from that detected this time (step P9). If there is a difference between both areas (YES at step P9), the processing at step P11 is then performed. However, both the areas are the same (NO at step P9), the processing is handed to step P10, at which it is determined if or not the contents of pieces of information delivered last time have been changed. At step P10, the server W makes a comparison between the current position known when the information was sent last time and a current position detected this time in order to find a situation where the current position has remained at the same point from the last time and information to be delivered in relation to the current position has yet to be updated. If such a situation is found, no new delivery will be carried out.

Accordingly, when contents of information have been changed from those delivered last time (YES at step P10), the processing will advance to step P11, while when such contents have not been changed (NO at step P10), steps P11 and P12 are jumped to directly go to step P13.

At step P11, the information providing server W delivers pieces of spot information to the certain terminal 1 that has accessed to the server W through the Internet IN. Hence, the delivered spot information is displayed on the terminal 1 handed by the information user (step P12). The processing at step P11 permits the server W to keep delivering information under either an occasion where the current position has been changed or a further occasion where information to be delivered has been updated without changes in the current position.

When the information user desires to view the delivered information, which has been displayed on the terminal 1 (YES at step P13), the processing is made to continue processing for changing display modes which will be described later. In contrast, in cases where the user does not show an intention to view the delivered information (NO at step P3), the server W determines whether the log-out from the system S is commanded or not (step P14). If the determination shows the log-out (YES at step P14), the server W performs the log-out processing at step P15, before terminating the processing, while if the log-out is not commanded (NO at step P14), the server W returns its processing to step P2 to repeat the above procedures.

In the case that the information user desires to view the delivered information (YES at step P13), the processing is further subjected to determination whether or not it is required to change display modes. If this determination reveals that the changes are required (YES at step P16), the processing is handed to step P17, at which one display mode is selected from three display modes in the main picture MG shown in FIG. 8. However, no changes are made (NO at step P16), the processing is made to skip step P17.

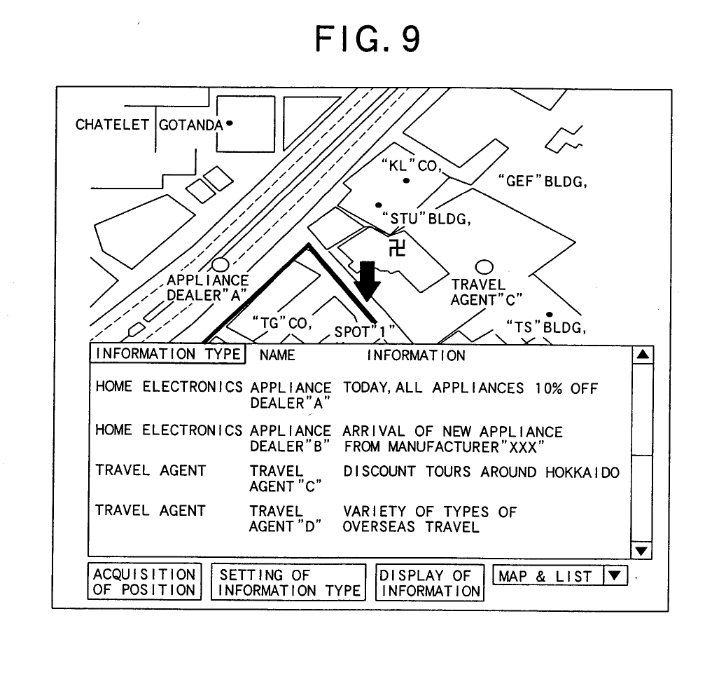

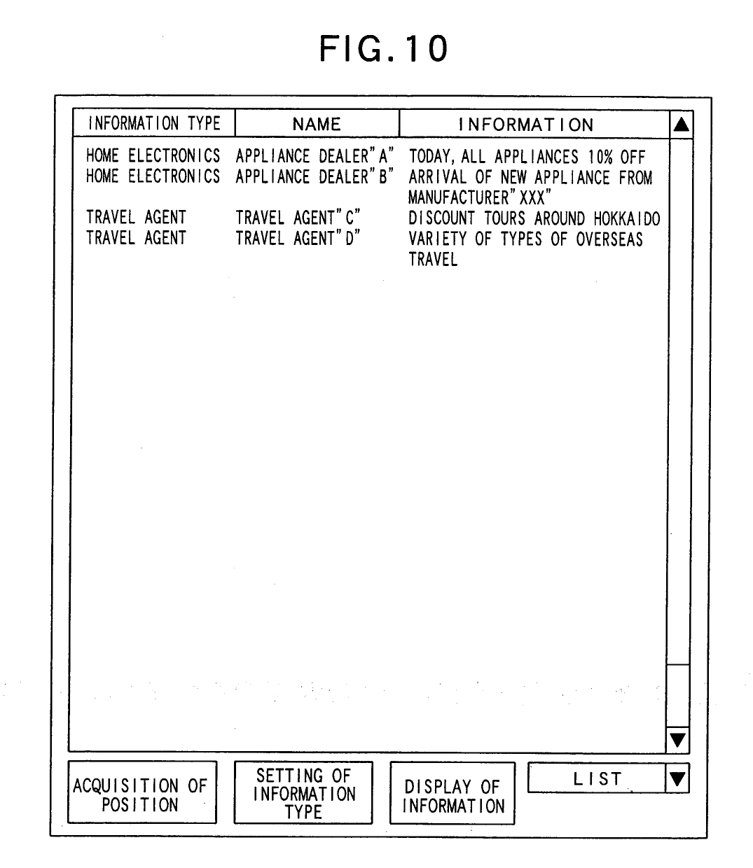

The three display modes consist of a map mode, a map & list mode, and a list mode. Under the map mode, the pictures is mainly occupied by a map, as shown in FIG. 8 (this picture also serves as the main picture MG that will be displayed initially). Under the map & list mode, the picture is formed fifty-fifty by a map and a list, as shown in FIG. 9. Further, under the list mode, as exemplified in FIG. 10, only a list is displayed.

By clicking either a desired icon on the map shown in FIG. 8 or a desired item on the list picture shown in FIG. 10, a desired shop (that is, a desired spot), for which it is desired to obtain a route guiding the shop, can be selected (steps P18 and P19). The processing is then made to go to step P20. Incidentally, when any item in the list is not subjected to a click operation at step P19 (NO at step P19), the processing is forced to directly proceed to step P25 described later.

At step P20, a line showing the route displayed at the last delivery of information (i.e., route line) and the list selections status are released, so that the route information that has been displayed so far is deleted. Then, pieces of necessary information in the list is reduced to be selected, and route information to be displayed this time is prepared (step P21). It is then confirmed by the server W whether or not a map on which a route is depicted has been displayed or not (step P22). When the map has already been displayed (YES at step P22), the processing is made to advance to step P24. However, when the map has not been displayed (NO at step P22), the display mode is switched over to the map & list mode in an automatic manner (step P23).

At step P24, on the map, the current position is connected to the specified icon by a route line L, as shown in FIGS. 8 and 9. Accordingly, the route line L on the map provides a recommend route that connects the current position to the desired spot. The route lien L thus serves as a guide line from the current position of the information user to a desired target shop.

As long as the information user desires to continue viewing the delivered information (YES at step P25), the processing is returned to step P16 to repeat a series of procedures stated above.

When the user desires to stop the view (NO at step P25), the processing is returned to step P14 to be subjected to the log-out determination, as described before. When the log-out is not desired (NO at step P14), the processing is returned to step P2 to repeat the foregoing procedures.

In addition, as shown in FIGS. 9 and 10, pieces of information that advertise shops neighboring to the route line L are displayed. Further, responsively to clicking a desired shop near in the main screen MG shown in FIG. 8, pieces of information that advertise the clicked shop are displayed on the map, together with the route line L connecting the current position to the clicked icon (shop).

In the main picture MG shown in FIG. 8, the position acquiring button is used to acquire a position in the manual acquisition mode, as described before. Hence it is possible to depict a self-icon at the acquired position repeatedly whenever the position acquiring button is pressed. Further, the information type setting button is usable when an information type setting button is read out and the information displaying button is used to manually display advertisement information. The advertisement information is transmitted from the information providing server W either automatically (at intervals) or manually.

As described above, in the information providing system S of the present embodiment, in cases where any of the spots previously registered is selected by an information user, data of a route connecting the selected spot and a current position of the information user is produced. The data of the route is displayed on a map, so that a route from the user's current position to the selected spot (such as a desired shop) is shown on the map. Showing this route enables the information user to go to the spot more readily.

Further, the registered spots are associated with information related to the spots, including advertisements for the spots. Hence by selecting a desired spot on a map, the information user is able to obtain various kinds of information about the selected spot, including the advertisement for the selected spot. Concurrently providing a user with both the route to a target spot and related information about the target spot makes it possible to give the spot a greater attraction to gather more users.

Since the spots and pieces of information related to the spots can be corrected or deleted by information providers, the correction and deletion give information providers with more convenience with regard to their operations.

Moreover, an information provider is allowed to set an area for displaying routes on the basis of the positions of spots. This configuration makes it possible that particular information users whose current positions are within the route display area are able to obtain information (such as routs and advertisements) about spots.

In the present embodiment, the current position of a user can be given as either a position that the terminal 1 acquires regularly in an automatic manner or a position determined in response to a manual operation of a user. In obtaining a user's current position, the degree of freedom for designing the system S and the terminal 1 can be raised. If both ways of obtaining the user's position are adopted, it is possible to acquire the user's position more steadily. Alternatively, selection may be made between a position that the terminal 1 acquires regularly in an automatic manner or a position determined in response to a manual operation of a user.

Only when the current position of a user is changed or information about the current position is updated, information related to a new spot can be delivered. Hence, for example, if the user moves, the user is able to have related information to new spots.

The present invention may be embodied in other specific forms without departing from the spirit or essential characteristics thereof. The above embodiments and modifications are therefore to be considered in all respects as illustrative and not restrictive, the scope of the present invention being indicated by the appended claims rather than by the foregoing description and all changes which come within the meaning and range of equivalency of the claims are therefore intended to be embraced therein.

For instance, the group in which the client guide service is provided can be adapted to a chain of shops. In such a case, the headquarter of the chain may become a manager of the group for the service, each shop may play a role as a group's member, and ordinary users may be information users, regardless of being membership or non-membership.

The entire disclosure of Japanese Patent Application No. 2001-354073 filed on Nov. 20, 2001 including the specification, claims, drawings and summary is incorporated herein by reference in its entirety.

What is claimed is:

1. An information providing server for providing a communicable terminal connected to the system via a communication network with both of a map to be displayed on the terminal and positional information depicted to be on the map, the server comprising:
a registration receiving unit configured to receive registration of a spot showing a desired position previously provided by an information provider;
a users' position acquiring unit configured to acquire information about a current position of an information user;
a first displaying unit configured to display on the map both of the spot registered by the spot registration receiving unit and the current position of the information user acquired by the users' position acquiring unit;
a route information producing unit configured to produce route information connecting the spot and the current position of the information user, in cases where the spot registered by the spot registration receiving unit is selected by the information user; and
a second displaying unit configured to display the produced route information on the map.

2. The information providing server of claim 1, further comprising a delivering unit configured to deliver to the terminal information related to the spot, the information including advertisement information about the spot,
wherein the registration receiving unit includes a unit configured to receive registration of the information related to the spot, the information being previously provided by the information provider together with the spot.

3. The information providing server of claim 2, where the registration receiving unit configured to allow the information provider to delete the received spot.

4. The information providing server of claim 1, where the registration receiving unit configured to allow the information provider to correct both of the received spot and the received information related to the spot.

5. The information providing server of claim 1, wherein the first displaying unit is configured to display a route display area correspondingly to the spot on the map, the route display area being set by the information provider.

6. The information providing server of claim 1, wherein the users' position acquiring unit is configured to accept, as the current position of the information user, either a first position acquired by the terminal itself or a second position set in response to a command given by the information user.

7. The information providing server of claim 6, wherein the first position and the second position are selectable by the information provider.

8. The information providing server of claim 1, wherein the delivering unit is configured to deliver the information related to the spot, in cases where the current position is either updated or changed.

9. A method of providing a communicable terminal connected to the system, via a commination network, with both of a map to be displayed on the terminal and positional information to be depicted on the map, comprising the steps of:
receiving registration of a spot showing a desired position previously provided by an information provider;
acquiring information about a current position of an information user;
first displaying on the map both of the registered spot and the acquired current position of the information user;
producing route information connecting the spot and the current position of the information user, in cases where the registered spot is selected by the information user; and
second displaying on the map the produced route information.

10. The method of claim 9, further comprising the step of delivering to the terminal information related to the spot,
wherein the information is previously provided by the information provider together with the spot, the information including advertisement information about the spot.

11. The method of claim 9, where the information related to the spot is erasable by the information provider.

12. The method of claim 9, where the spot and the information related to the spot are both correctable by the information provider.

13. The method of claim 9, wherein a route display area correspondingly to the spot is displayed on the map in the first displaying step, the route display area being set by the information provider.

14. The method of claim 9, wherein the acquired current position of the information user is either a first position acquired by the terminal itself or a second position set in response to a command given by the information user.

15. The method of claim 14, wherein the first position and the second position are selectable by the information provider.

16. The method of claim 9, wherein the information related to the spot is delivered in the delivering step, in cases where the current position is either updated or changed.

17. A program installed in a computer system incorporated in an information providing server for providing a communicable terminal connected to the system via a communication network with both of a map to be displayed on the terminal and positional information to be depicted on the map, the program enabling the computer system to functionally serve as:
a spot registration receiving unit configured to receive registration of a spot showing a desired position previously provided by an information provider;
a users' position acquiring unit configured to acquire information about a current position of an information user;
a first displaying unit configured to display on the map both of the spot registered by the spot registration receiving unit and the current position of the information user acquired by the users' position acquiring unit;
a route information producing unit configured to produce route information connecting the spot and the current position of the information user, in cases where the spot registered by the spot registration receiving unit is selected by the information user; and
a second displaying unit configured to display the produced route information on the map.
